(19) United States
(12) Patent Application Publication
(10) Pub. No.: US 2026/0074245 A1
(43) Pub. Date: Mar. 12, 2026

(54) FUEL CELL SYSTEM WATER SEPARATOR EFFICIENCY

(71) Applicant: FORD GLOBAL TECHNOLOGIES, LLC, Dearborn, MI (US)

(72) Inventors: Xiaogang ZHANG, Novi, MI (US); George Aristidis PAPAIOANNOU, Livonia, MI (US); Craig Winfield PETERSON, West Bloomfield, MI (US); Anthony D. WEST, Belleville, MI (US); Matthew RILEY, Ann Arbor, MI (US); Ryan MA, Canton, MI (US)

(73) Assignee: FORD GLOBAL TECHNOLOGIES, LLC, Dearborn, MI (US)

(21) Appl. No.: 18/828,265

(22) Filed: Sep. 9, 2024

(51) Int. Cl. H01M 8/04119; B01D 45/08; H01M 8/04089

(52) U.S. Cl. CPC H01M 8/04164; B01D 45/08; H01M 8/04097

(57) ABSTRACT

A device for separating liquid water from a recirculation gas stream in a fuel cell system includes an outer cylindrical tank. This tank includes a sidewall with a gas inlet port, a top wall, and a bottom with a water outlet port. The gas inlet port is designed to receive an input stream from the anode side of the fuel cell system. Inside the outer cylindrical tank, an inner protection tube is in fluid communication with the gas outlet port. This inner protection tube allows separated gas to flow to the gas outlet port while preventing liquid water from entering the gas outlet. The inner protection tube has an entry opening for receiving the separated gas flow. The anode knockout device is modified to reduce the formation of water droplets that might be entrained in the recirculation gas steam.

### TECHNICAL FIELD

In at least one aspect, methods and systems for separating liquid water from the recirculation gas in a fuel cell system are provided.

### BACKGROUND

In typical fuel cell systems, an Anode Knock Out (AKO) device is used to separate water, a byproduct of the chemical reaction inside the stack, from the recirculation gas to reuse the leftover hydrogen.

### SUMMARY

In at least one aspect, an anode knockout device for separating liquid water from a recirculation gas stream in a fuel cell system is provided. The anode knockout device includes an outer cylindrical tank. The outer cylindrical tank includes a sidewall that includes a gas inlet port, a top wall including a gas outlet port, and a bottom wall. A water outlet port is attached to the sidewall or the bottom wall. The gas inlet port includes an internal surface and is configured to receive an input stream from the anode side of the fuel cell system. Inside the outer cylindrical tank, an inner protection tube is in fluid communication with the gas outlet port. This inner protection tube allows separated gas to flow to the gas outlet port while inhibiting liquid water from entering the gas outlet. The inner protection tube has an entry opening for receiving the recirculation gas stream flow. The anode knockout device optionally includes a water separator between the inner protection tube and the water outlet port configured to inhibit water splash back into the inner protection tube. Advantageously, the anode knockout device is modified to reduce (i.e., inhibit) the formation of water droplets that might be entrained in the recirculation gas steam.

In another aspect, a device for separating liquid water from a recirculation gas stream in a fuel cell system is provided. The device includes an outer cylindrical tank having a sidewall with a gas inlet port, a top wall including a gas outlet port, and a bottom wall. A water outlet port is attached to the sidewall or the bottom wall the gas inlet port includes an internal surface and is configured to receive an input stream from an anode side of the fuel cell system. An inner protection tube is positioned within the outer cylindrical tank in fluid communication with the gas outlet port. The inner protection tube is configured to allow separated gas flow to the gas outlet port while preventing liquid water from being carried into the gas outlet port. The inner protection tube defines an entry opening for receiving the separated gas flow. Advantageously, a ratio of a first distance to a top of an inner surface of the gas inlet port to a length of inner protection is optimized to inhibit water droplets from being entrained in recirculation gas steam. The devices can further include a water separator between the inner protection tube and the water outlet port configured to inhibit water splash back into the inner protection tube.

In another aspect, an anode knockout device for separating liquid water from a recirculation gas stream in a fuel cell system is provided. The anode knockout includes an outer cylindrical tank that includes a sidewall having a gas inlet port, a top wall including a gas outlet port, and a bottom wall. The gas inlet port includes an internal surface and is configured to receive an input stream from the anode side of the fuel cell system. A water outlet port is attached to the sidewall or the bottom wall. The anode knockout also includes an inner protection tube assembly positioned within the outer cylindrical tank in fluid communication with the gas outlet port. The inner protection tube assembly includes a first inner protection component and a second protection tube component, configured to cooperate to allow separated gas flow to the gas outlet port while preventing liquid water from being carried into the gas outlet. The anode knockout device optionally includes a water separator between the inner protection tube and water outlet port configured to inhibit water splash back into the inner protection tube assembly.

In at least one aspect, an anode knockout device for separating liquid water from a recirculation gas stream in a fuel cell system is provided. The anode knockout device includes an outer cylindrical tank. The outer cylindrical tank includes a sidewall that includes a gas inlet port, a top wall including a gas outlet port, and a bottom wall. A water outlet port is attached to the sidewall or the bottom wall. The gas inlet port includes an internal surface and is configured to receive an input stream from the anode side of the fuel cell system. Inside the outer cylindrical tank, an inner protection tube is in fluid communication with the gas outlet port. This inner protection tube allows separated gas to flow to the gas outlet port while inhibiting liquid water from entering the gas outlet. The inner protection tube has an entry opening for receiving the recirculation gas stream flow. The anode knockout device optionally includes a water separator between the inner protection tube and the water outlet port configured to inhibit water splash back into the inner protection tube. Advantageously, the top wall includes a plurality of concentric ribs to inhibit water from entering the inner protection tube.

In another aspect, methods and systems for separating liquid water from the recirculation gas in a fuel cell system are provided. This method increases the efficiency of water removal in fuel cell systems by addressing specific issues associated with the Anode Knock Out (AKO) device. The AKO device separates water, a byproduct of the chemical reaction within the fuel cell stack, from the recirculation gas to allow the reuse of leftover hydrogen.

In another aspect, methods and designs for the AKO device in fuel cell systems offer higher efficiency by reducing gas flow velocity at critical points, increasing water droplet collection through multiple flow impingements, and providing effective yet comprehensive solutions for enhanced water separation.

In another aspect, the anode knockout devices provide higher efficiency by reducing water drops from exiting the gas outlet tube while lowering gas flow velocity at the bottom of the protection tube.

In another aspect, the anode knockout device creates multiple flow impingements to collect water droplets on the surface of the protection tube (non-direct flow).

In another aspect, the anode knockout device provides a unique concept that features additional layers of control for humidity entering back into the fuel cell stack.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic of a prior art anode knockout device.

FIG. 2. Schematic of a fuel cell system that includes an anode knockout device.

FIG. 3A. Side view of an anode knockout device that can be used in the fuel cell system of FIG. 2.

FIG. 3B. Top view of an anode knock-out device that can be used in the fuel cell system of FIG. 2.

FIG. 3C. Vertical cross-sectional view of the anode knockout device that can be used in the fuel cell system of FIG. 2.

FIG. 4. Vertical cross-sectional view with an inner protection tube 60 having a chamfered edge.

FIG. 5A. Vertical cross-sectional view of an anode knockout device with an exhaust gas inlet port modified to redirect the flow of the input exhaust stream.

FIG. 5B. Horizontal cross-sectional view of an anode knockout device with an exhaust gas inlet port modified to redirect the flow of the input exhaust stream.

FIG. 6. Vertical cross-sectional view of anode knockout device 40 with a modified top wall.

FIG. 7A. Vertical cross-sectional view of an anode knockout device having an inner protection tube with at least a section having a greater diameter than the gas outlet port.

FIG. 7B. Vertical cross-sectional view of an anode knockout device having an inner protection tube with at least a section having a greater diameter than the gas outlet port.

FIG. 7C. Vertical cross-sectional view of an anode knockout device having an inner protection tube with at least a section having a greater diameter than the gas outlet port.

FIG. 8A. Vertical cross-sectional view of an anode knockout device with an inner protection tube assembly having two curved protection shields.

FIG. 8B. Horizontal cross-sectional view of an anode knockout device with an inner protection tube assembly having two curved protection shields.

FIG. 9A. Vertical cross-sectional view of an anode knockout device with an inner protection tube assembly having two concentric tubes.

FIG. 9B. Horizontal cross-sectional view of an anode knockout device with an inner protection tube assembly having two concentric tubes.

FIG. 10. Schematic of a testing system for evaluating the anode knockout device.

FIG. 11. Results of testing various anode knockout device designs using the testing system of FIG. 10.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

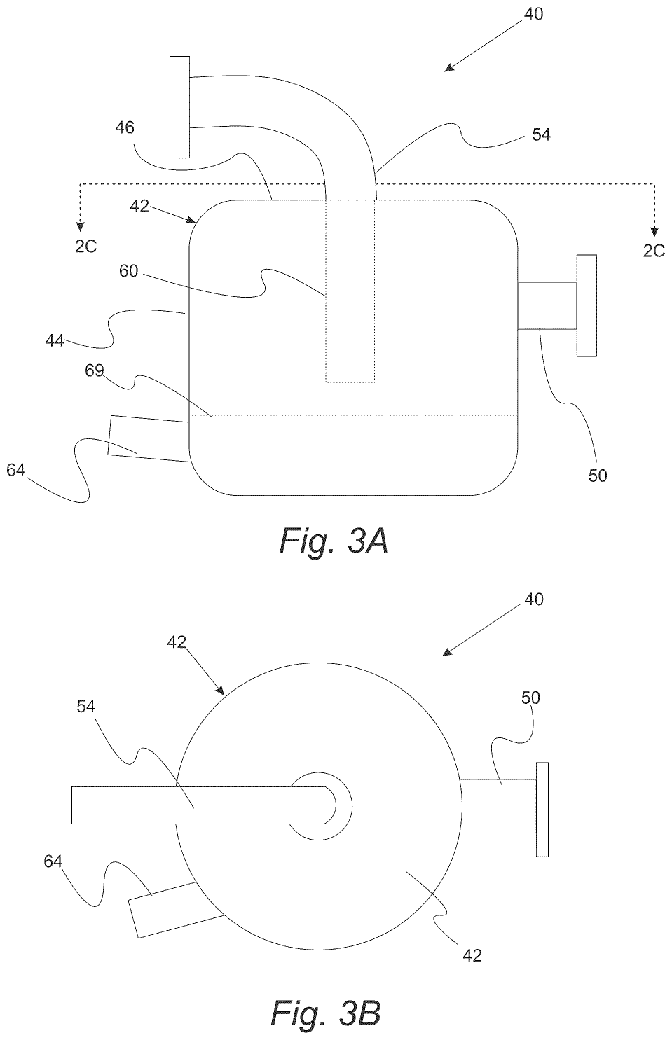

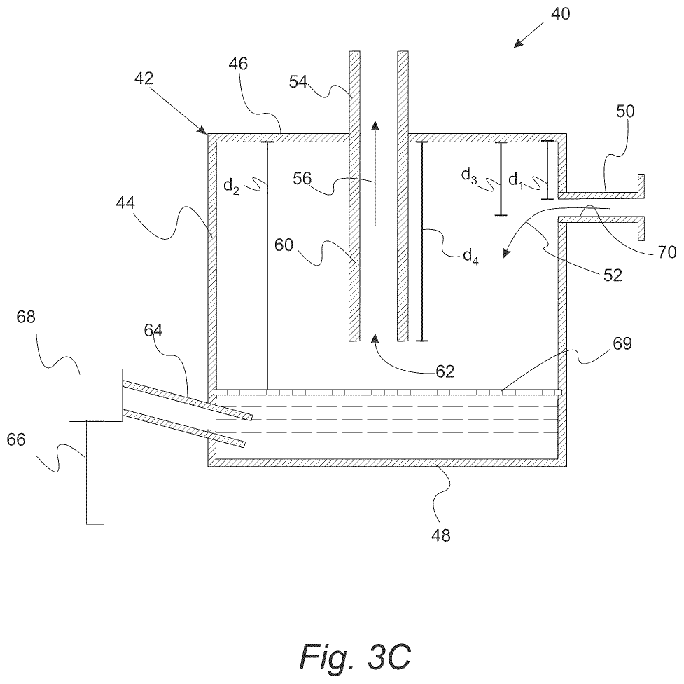

As with reference to the Figures, the same reference numerals may be used herein to refer to the same parameters and components or their similar modifications and alternatives. For purposes of description herein, the directional terms “upper,” “lower,” “right,” “left,” “rear,” “front,” “vertical,” “horizontal,” and derivatives thereof shall relate to the present disclosure as oriented in FIGS. 3A, 3C, 4, 5A, 6, 7A, 7B, 7C, 8A, and 9A. This orientation ensures that liquid water collects under the force of gravity at the bottom. However, it is to be understood that the present disclosure may assume various alternative orientations, except where expressly specified to the contrary. It is also to be understood that the specific devices and processes illustrated in the drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

### Abbreviations:

“AKO” means anode knockout.

“OSA” means otherwise same as.

J “FCS” means fuel cell system.

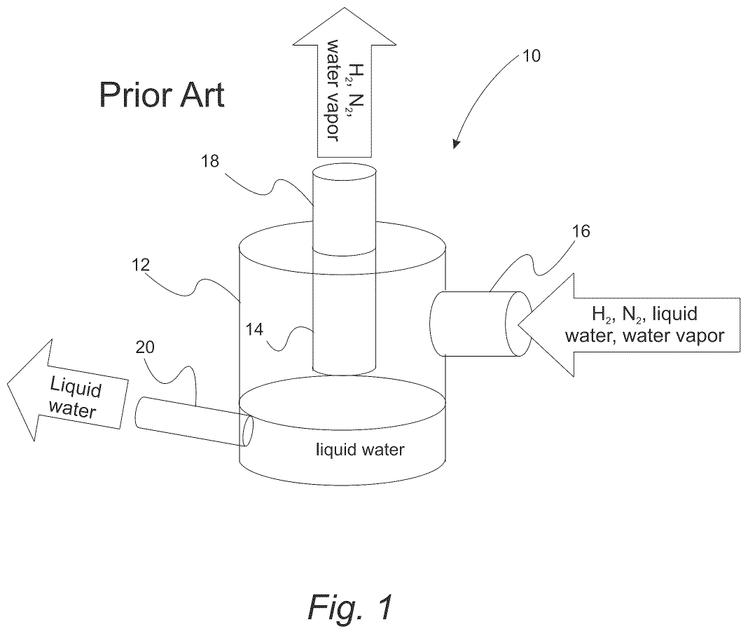

As depicted in FIG. 1, an existing AKO design 10 includes an outer cylinder tank 12 with a small protection tube 14 positioned therein. The protection tube is intended to prevent water droplets from directly flowing into the gas outlet tube with the gas flow. AKO design 10 includes gas inlet port 16 that receives exhaust from the anode side of a fuel cell system and recirculating gas outlet tube 18 that recycles gas to the fuel cell stack with liquid water removed therefrom. This configuration results in high gas velocity at the gas inlet port 16. This high velocity can cause dripping water to be blown back into the recirculating gas outlet tube 18, thereby decreasing the efficiency of water separation. Water is collected at the bottom of the outer cylindrical tank through direct impingement on the outer surface of the protection tube and the inner surface of the outer cylindrical tank. However, due to the small size of the protection tube, the gas velocity at the bottom flow inlet is high, which can blow dripping.

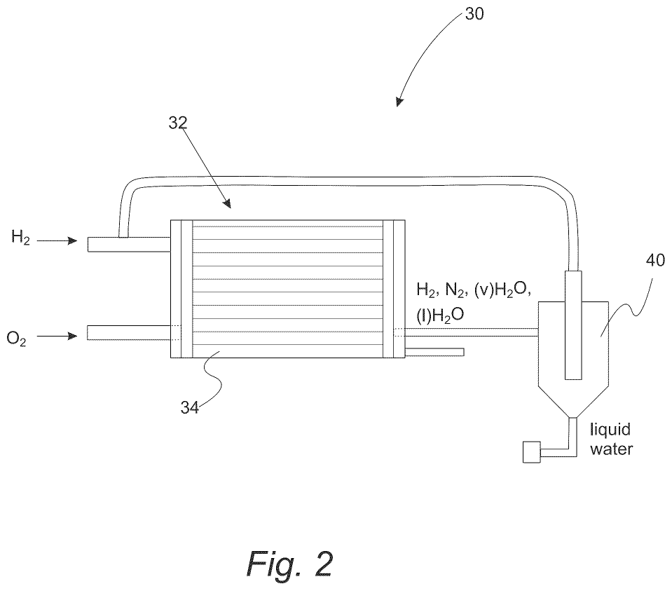

Referring to FIG. 2, a schematic of a fuel cell system that includes an anode knockout device, is provided. Referring to FIG. 1, a schematic of a fuel cell system with an anode knockout is provided. Fuel cell system 30 includes a fuel cell stack 32 which includes a plurality of fuel cells 34. Typically, hydrogen gas is provided to the anodes while oxygen is provided to the cathodes. Anode knockout device 40 receives an exhaust from the anode side of fuel cell stack 32. This exhaust can include hydrogen gas (H₂), nitrogen, liquid water, and water vapor. Liquid water can be exited from anode knockout device 40 via a purge drain valve 68.

Referring to FIGS. 3A, 3B, and 3C, schematics of an anode knock-out device that can be incorporated into the fuel cell system of FIG. 1 are provided. FIG. 3A provides a side view while FIG. 3B provides a top view of the anode knock-out device. FIG. 3C is a vertical cross-sectional view of the anode knockout device. Anode knockout device 40 includes an outer cylindrical tank 42 having a sidewall 44, a top wall 46, and a bottom wall 48. Sidewall 44 includes a gas inlet port 50 configured to receive an input stream 52 (e.g., the exhaust) from the anode side of the fuel cell stack 32 of FIG. 1. Top wall 46 includes a gas outlet port 54 through which a recirculation gas stream 56 flows. Typically, recirculation gas stream 56 includes H₂, N₂, and possibly some water vapor. It is desirable that recirculation gas stream 56 includes a minimal amount of water droplets. An inner protection tube 60 is positioned within the outer cylindrical tank 42 and is in fluid communication with the gas outlet port 54. The inner protection tube 60 is configured to allow separated gas flow (i.e., recirculation gas stream 56) to the gas outlet port while inhibiting (e.g., preventing) liquid water from being carried into the gas outlet. The inner protection tube defines an entry opening 62 for receiving the separated gas flow. A water outlet port 64 is positioned at the bottom of anode knockout device 20 either at the bottom of the sidewall or in the bottom wall. In a refinement, a water outlet tube 66 in fluid communication with the water outlet port 64 is positioned to collect liquid water separated from the gas stream within the outer cylindrical tank. Purge drain valve 68 can be used to control the flow of water out of anode knockout device 40. In a refinement, water separator 69 is positioned inside anode knockout device 40 between the inner protection tube 60 and water outlet port 63. Typically, water separator 69 is a grid (e.g., a stainless steel grid) configured to inhibit water splash back into inner protection tube 60. Advantageously, anode knockout device 40 is modified to reduce (i.e., inhibit) the formation of water droplets that might be entrained in the recirculation gas steam 56. In this regard, the top wall 46, the input port 50, and the inner protection tube 60 are modified for this purpose.

It should be appreciated that the anode knockout device 40 is not limited by its materials of construction which can be metal (e.g., stainless steel) or plastic (e.g., nylon, polyethylene, Teflon, and the like). Anode knockout device 40 can be formed by molding, 3D printing, or any suitable process known in the art. Similarly, the anode knockout device 40 is not limited by its spatial dimensions. For example, the walls of the components can be of any suitable thickness, which are typically from 0.1 inch to 0.25 inches.

In another aspect, the ratio of a distance d₁ from the bottom surface of top wall 46 to the top of the inner surface 70 of gas inlet port 50 (i.e., the closest point of the inner surface 70 to top wall 46) to the distance d₂ from the bottom surface of top wall 46 to the top surface of the water separator 69 is optimized to inhibit water droplets from being entrained in recirculation gas steam 56. In a refinement, the ratio of d₁ to d₂ is at least 0.1. In some refinements, the ratio of d₁ to d₂ is at least 0.07, 0.08, 0.09, 0.1, 0.12, 0.125, 0.13, or 0.14, and at most, 0.16, 0.15, 0.14, or 0.13. These values are greater than a prior art design that has a ratio of d₁ to d₂ of 0.054.

In another aspect, the ratio of a distance d₃ from the bottom surface of top wall 46 to the bottom of the inner surface 70 of gas inlet port 50 (i.e., the farthest point of the inner surface 70 to top wall 46) to the length d₄ of inner protection 60 is optimized to inhibit water droplets from being entrained in recirculation gas steam 56. The length d₄ is the extent of inner protection tube 60 into cylindrical tank 42. In a refinement, the ratio of d₃ to d₄ is at least 0.5. In some refinements, the ratio of d₃ to d₄ is at least 0.48, 0.49, 0.5, 0.51, or 0.52, and at most 0.8, 0.7, 0.6, 0.59, 0.58, 0.56, or 0.54. These values are greater than a prior art design that has a ratio of d₃ to d₄ of 0.445.

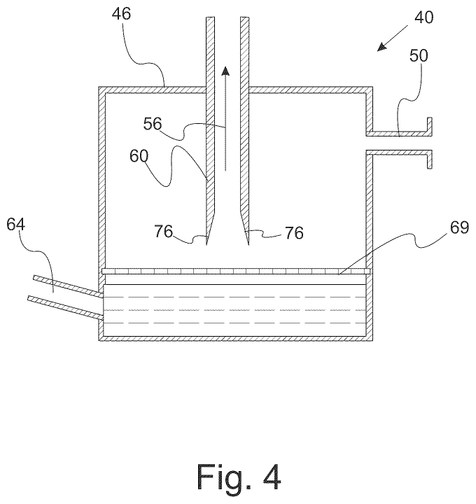

Referring to FIG. 4, a cross-sectional view with an inner protection tube 60 having a chamfered edge is provided. As depicted, edge 76 of inner protection tube 60 is chamfered (e.g., angled). The chamfered edge can be either on the inner or outer surface of the inner protection tube 60. In a refinement, the chamfered edge extends from 0.25 to 1 inch from the bottom of the inner protection tube 60. As demonstrated below, this configuration reduces the formation of water droplets and therefore, the entrainment of such droplets in the recirculation gas stream 56.

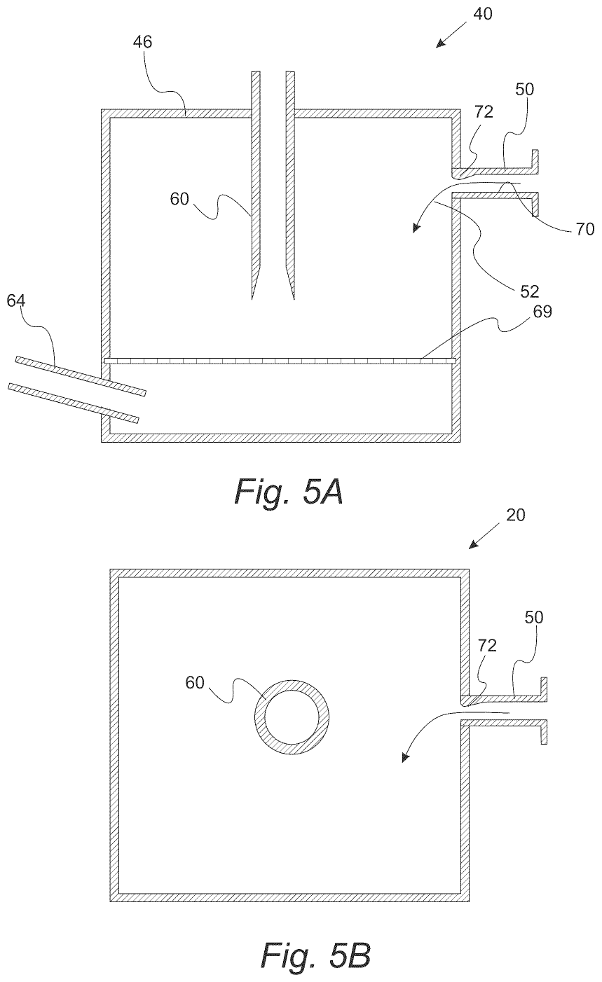

Referring to FIGS. 5A and 5B, cross-sectional views of anode knockout device 40 with a gas inlet port 50 modified to redirect the flow of input stream 52 are provided. As depicted, inner surface 70 is configured to direct gas flow (of inlet stream 52) downward and laterally away from the inner protection tube 60. In this regard, protrusions or contours 72 can be formed on the inner surface 70 to direct the flow in this manner.

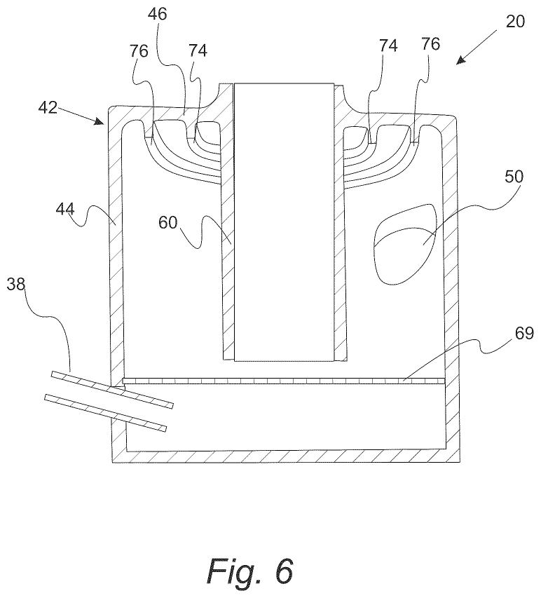

Referring to FIG. 6, a cross-sectional view of anode knockout device 40 with a modified top wall is provided. Top wall 46 of cylindrical tank 42 includes a plurality of concentric ribs 74, 76 to inhibit water from entering the inner protection tube. In a refinement, top wall 46 includes two concentric ribs.

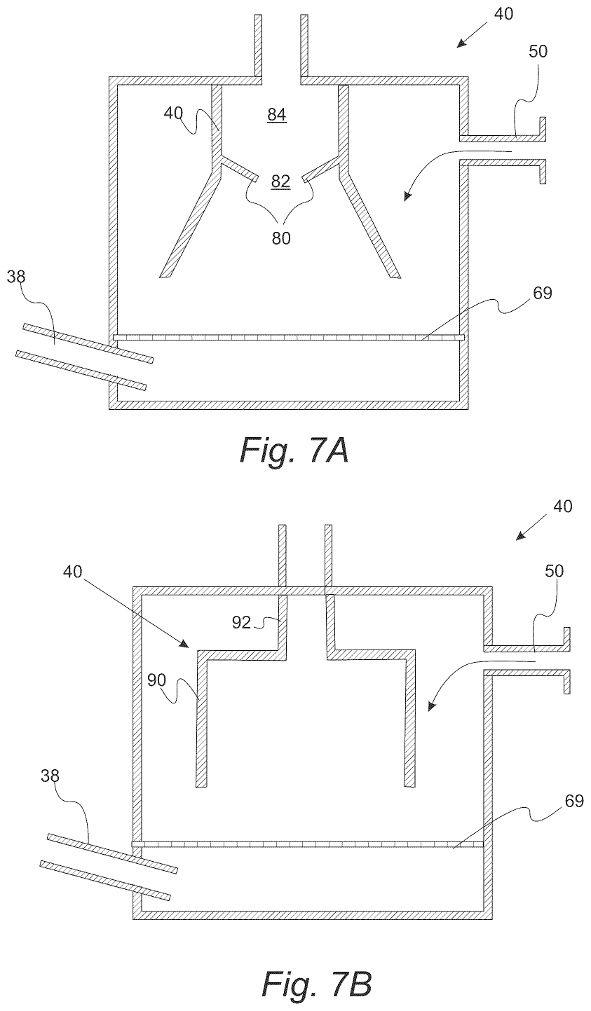

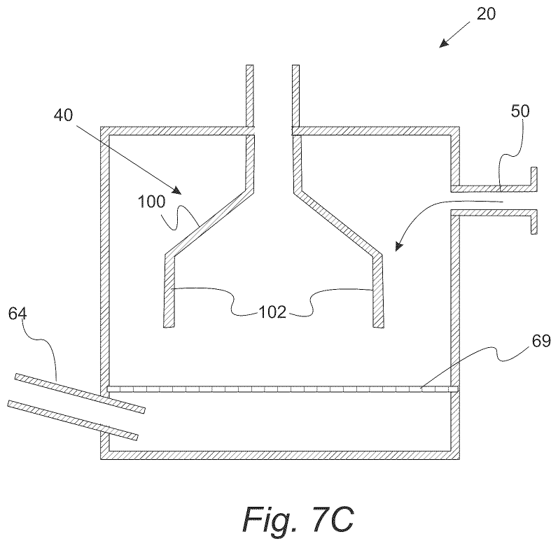

Referring to FIGS. 7A, 7B, and 7C, cross-sectional views of anode knockout device 40 having an inner protection tube with at least a section having a greater diameter than the diameter of gas outlet port 54 are provided. In a refinement, the inner protection tube 60 has a section with a diameter that is at least two times greater than the diameter of the gas outlet port. In a further refinement, these designs use a larger protection tube with a diverging cone shape at the bottom, as opposed to a small, straight protection tube. This design offers two significant benefits: first, the increased gas velocity outside the protection tube enhances the direct impingement of water droplets on the outer surface of the protection tube, thereby reducing the number of water droplets inside the device. Second, the reduced gas velocity at the bottom of the protection tube minimizes the likelihood of dripping water at the bottom edge of the protection tube being blown into the gas outlet tube.

Referring to FIG. 7A, at least a portion of the inner protection tube 60 flares outward in a direction towards the entry opening. Therefore, inner protection tube 60 incorporates an inner upside-down cone 80 within the protection tube. The inlet 82 of the inner cone 80 is smaller than its outlet 84, effectively collecting water droplets and film before they enter the inlet of the inner cone 80.

Referring to FIG. 7B, inner protection tube 60 includes a two-section protection tube. As depicted, inner protection tube 60 includes first section 90 and second section 92, where the first section 90 is downstream of the second section 92 during operation of the anode knockout device 40. The downstream section 90 has a larger diameter than the second section 92, thereby reducing gas velocity as it enters the two-step protection tube.

Referring to FIG. 7C, inner protection tube 60 also includes a two-section protection tube. The top portion 100 is shaped as a diverging cone, and the bottom portion 102 is shaped as a straight tube with a significantly larger diameter. The top portion 100 is downstream of the bottom portion 102 during the operation of the anode knockout device 40. These design concepts collectively reduce gas velocity upon entering the protection tube and prevent water droplets from being blown upwards into the protection tube.

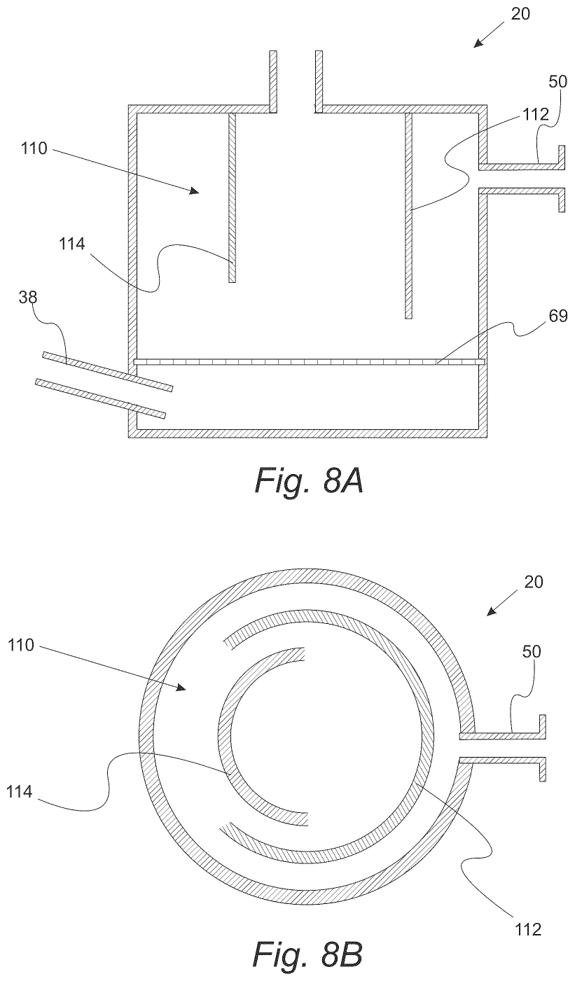

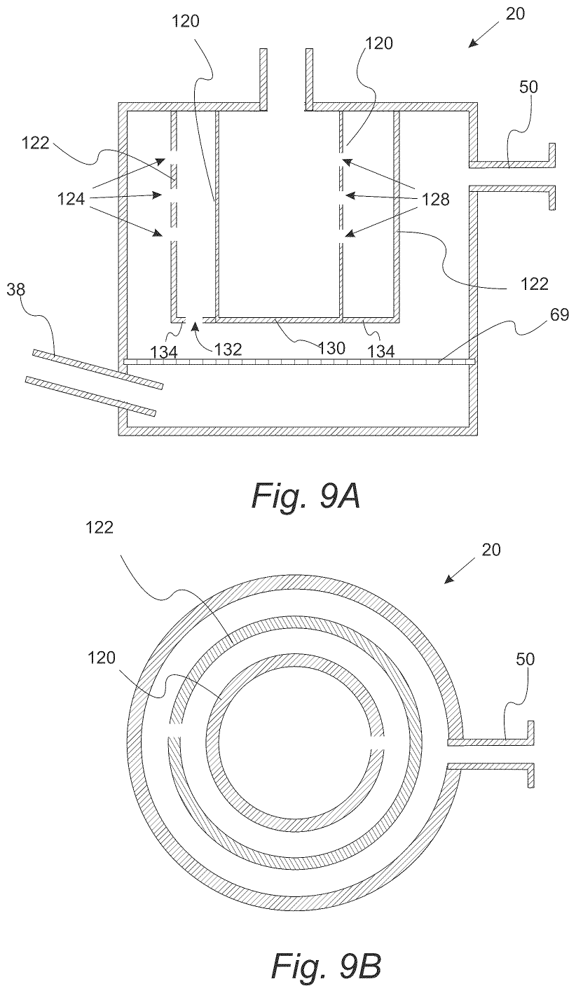

In another aspect, an anode knockout device for separating liquid water from a recirculation gas stream in a fuel cell system is provided. The anode knockout device includes an outer cylindrical tank with a sidewall with a gas inlet port. The anode knockout device further includes a top wall having a gas outlet port and an internal surface, and a bottom wall having a water outlet port. The gas inlet port is configured to receive an input stream from the anode side of the fuel cell system. The anode knockout also includes an inner protection tube assembly positioned within the outer cylindrical tank in fluid communication with the gas outlet port. The inner protection tube assembly includes a first inner protection component and a second protection tube component configured to cooperate to allow separated gas flow to the gas outlet port while preventing liquid water from being carried into the gas outlet. FIGS. 8A, 8B, 9A, and 8B depict some variation of this aspect.

Referring to FIGS. 8A and 8B, cross-sectional views of an anode knockout device with an inner protection tube having two curved protection shields instead of a small, straight, circular protection tube are provided. Anode knockout device 40 includes an inner protection tube assembly 110 that includes a first protection shield 112 and a second protection shield 114. The first protection shield 112 is larger than the second protection shield 114. Moreover, the first protection shield 112 is closer to inlet port 50, with the outer side facing inlet port 50. In other words, the larger front protection shield 112 is designed and installed such that its opening section is opposite to the device inlet port 50. The smaller rear shield 114 is designed and installed with its opening section facing the device inlet port 50, opposite the opening section of the front protection shield 112. This design provides three significant benefits: large water droplets are collected on the outer surface of the front protection shield due to their large momentum; intermediate water droplets are collected on the rear inner surface of the device's outer tube; and small water droplets are collected on the outer surface of the rear shield.

Referring to FIGS. 9A and 9B, cross-sectional views of an anode knockout device having two circular protection tubes installed concentrically. Anode knockout device 40 includes an inner tube 120 and an outer tube 122. The inner tube 120 has a smaller diameter than the outer tube 122. Moreover, the smaller inner tube 120 is positioned inside the larger outer tube 122. The outer tube 122 features a first column of perforation holes 124 on its rear side, opposite to the gas inlet port 50, while the inner tube 120 has a second column of perforation holes 128 on its front side, towards the gas inlet port 50. The bottom side 130 of the inner tube 120 is completely sealed. Water drainage hole 132 is designed on the rear side of the bottom seal 134 of the outer tube 122. This design offers four benefits: large water droplets are collected on the outer surface of the outer protection tube due to their large momentum; intermediate water droplets are collected on the rear inner surface of the device's outer tube; small water droplets are collected on the outer surface of the inner protection tube; and very small water droplets are collected on the inner surface of the outer protection tube.

It should be appreciated the two or more of the anode knockout devices of FIGS. 3 to 9 can be combined into a single anode knockout device.

The following examples illustrate the various embodiments of the present invention. Those skilled in the art will recognize many variations that are within the spirit of the present invention and scope of the claims.

The anode knockout devices are evaluated for efficiency in collecting water and preventing water droplets from exiting with the gas. Several AKO designs (C1-C4) are compared to the baseline design to assess efficiency. The design codes are as follows:
C1: adjustment of the positioning of the gas inlet port compared to the length of the inner protection tube (FIG. 3C).
C2: chambered edges on the inner protection tube (FIG. 4).
C3: directing the flow of the inlet gas away from the inner protection tube (FIGS. 5A and 5B).
C4: inclusion of ribs on the top wall of the outer cylinder tank (FIG. 6).

Features include reduced gas flow velocity, multiple flow impingements for water collection, and unique feature variations to control humidity re-entering the fuel cell stack. Designs C1-C4 are compatible with the baseline design's injection moldability. The testing provides an understanding of the constantly changing gas flow direction/deviation of water droplets from following main gas flow direction.

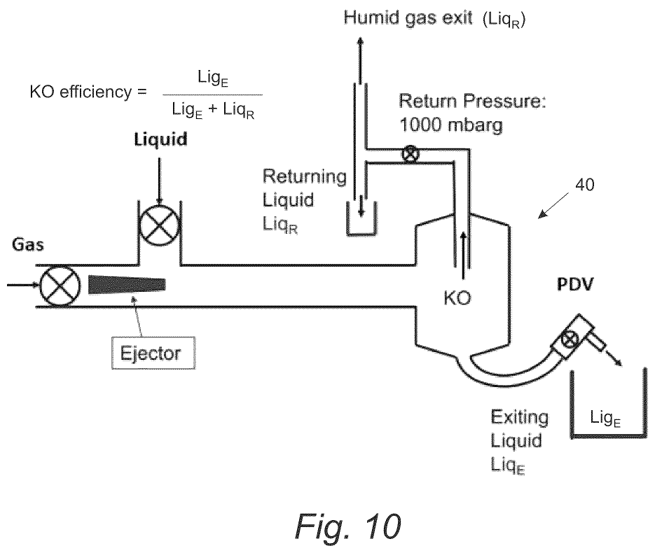

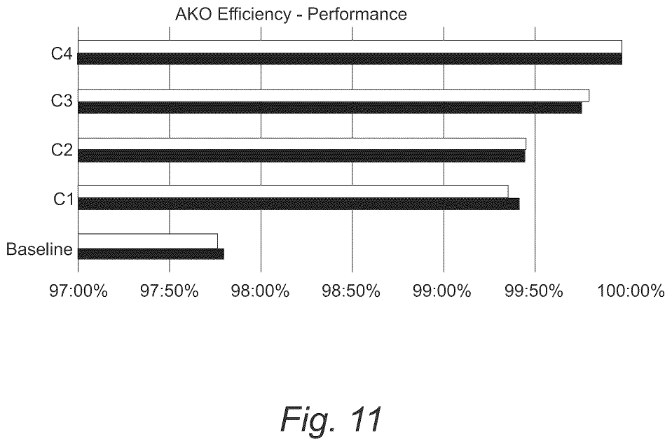

FIG. 10 provides a schematic of a testing system for evaluating the anode knockout design set forth above. FIG. 11 provides the test results. The efficiency is determined from the collection of liquid Liq_{E} from the water outlet tube (i.e., the bucket) and of Liq_{R} from the recycle gas stream (i.e., the cap). The results are also summarized in Table 1.

TABLE 1
Efficiency results

| AOTS Parameters | | RS7 | | | |
|---|---|---|---|---|---|
| H20 - 345 ml/m | RS5 | Features | RS7 | RS7 | RS7 |
| N2 = 475 SLPM | Features | (raised | w/Straw | w/Inlet | w/Roof |
| DC = 0.6/3.3 | (clear) | roof) | Chamfer | Bump | Rings |
| (on/off) | CW Inlet | CW Inlet | OSA C1 | OSA C2 | OSA C3 |
| | Baseline | C1 | C2 | C3 | C4 |
| Run 1 | | | | | |
| Bucket | 3124.9 | 3185.4 | 3177.5 | 3192.9 | 3215.7 |
| Cap | 70.3 | 18.7 | 17.7 | 8 | 0.7 |
| Run 2 | | | | | |
| Bucket | 3123.9 | 3187.5 | 3183.2 | 3201.5 | 3211.7 |
| Cap | 71.3 | 20.7 | 17.7 | 6.6 | 0.9 |
| Run 1% efficiency | 97.80% | 99.42% | 99.45% | 99.75% | 99.98% |
| Run 2% efficiency | 97.77% | 99.35% | 99.45% | 99.79% | 99.97% |

From FIG. 11 and table 1, it is observed that the efficiency progressively increases as the AKO design features are combined together. Combination of all the features of C1-C4 provides the greatest efficiency.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A device for separating liquid water from a recirculation gas stream in a fuel cell system, comprising:
an outer cylindrical tank having a sidewall having a gas inlet port, a top wall including a gas outlet port, and a bottom wall, a water outlet port is attached to the sidewall or the bottom wall, the gas inlet port includes an internal surface and is configured to receive an input stream from an anode side of the fuel cell system;
an inner protection tube positioned within the outer cylindrical tank in fluid communication with the gas outlet port, the inner protection tube configured to allow separated gas flow to the gas outlet port while preventing liquid water from being carried into the gas outlet port, the inner protection tube defining an entry opening for receiving the separated gas flow, wherein a ratio of a first distance to a top of an inner surface of the gas inlet port to a length of the inner protection tube is optimized to inhibit water droplets from being entrained in recirculation gas steam; and
a water separator between the inner protection tube and the water outlet port configured to inhibit water splash back into the inner protection tube.

2. The device of claim 1, wherein the ratio of a distance from a bottom surface of the top wall to the top of the inner surface of the gas inlet port to a distance from the bottom surface of the top wall to a top surface of the water separator is at least 0.1.

3. The device of claim 1, wherein the ratio of a distance from a bottom surface of the top wall to a bottom of the inner surface of the gas inlet port to the length of the inner protection tube is at least 0.5.

4. The device of claim 1, wherein a water outlet tube is in fluid communication with the water outlet port positioned to collect the liquid water separated from a gas stream within the outer cylindrical tank.

5. The device of claim 1, wherein the inner protection tube includes a chamfered edge.

6. The device of claim 5, wherein the gas inlet port has a shape configured to direct gas flow downward and laterally away from the inner protection tube.

7. The device of claim 5, wherein the top wall includes a plurality of concentric ribs to inhibit water from entering the inner protection tube.

8. The device of claim 1, wherein at least a portion of the inner protection tube flares outward in a direction towards the entry opening.

9. The device of claim 1, wherein the inner protection tube includes a section having a diameter that is greater than the diameter of the gas outlet port.

10. The device of claim 1, wherein the inner protection tube has a section with a diameter that is at least two times greater than the diameter of the gas outlet port.

11. The device of claim 1, wherein the inner protection tube has an upside-down cone positioned therein.

12. A fuel cell stack including the device of claim 1 in fluid communication with the anode side of the fuel cell stack.

13. A device for separating liquid water from a recirculation gas stream in a fuel cell system, comprising:
an outer cylindrical tank having a sidewall having a gas inlet port, a top wall including a gas outlet port, and a bottom wall, a water outlet port is attached to the sidewall or the bottom wall, the gas inlet port includes an internal surface and is configured to receive an input stream from an anode side of the fuel cell system;
an inner protection tube assembly positioned within the outer cylindrical tank in fluid communication with the gas outlet port, the inner protection tube assembly including a first inner protection component and a second protection tube component configured to cooperate to allow separated gas flow to the gas outlet port while preventing liquid water from being carried into the gas outlet port; and
a water separator between the inner protection tube assembly and the water outlet port configured to inhibit water splash back into the inner protection tube assembly.

14. The device of claim 13, wherein the inner protection tube assembly includes a first protection shield and a second protection shield, the first protection shield being larger than the second protection shield.

15. The device of claim 14, wherein the first protection shield is closer to the gas inlet port than the second protection shield, with an outer side of the first protection shield facing the gas inlet port and an opening section of the second protection shield, opposite the opening section of the first protection shield.

16. The device of claim 13, wherein the inner protection tube assembly includes an inner tube and an outer tube, the inner tube having a smaller diameter than the outer tube.

17. The device of claim 16, wherein the outer tube includes a first column of perforation holes on its rear side, opposite to the gas inlet port, while the inner tube has a second column of perforation holes on its front side, towards the gas inlet port.

18. The device of claim 17, wherein a bottom side of the inner tube is completely sealed.

19. The device of claim 17, wherein a bottom side of the outer tube includes a water drainage hole.

20. A device for separating liquid water from a recirculation gas stream in a fuel cell system, comprising:
an outer cylindrical tank having a sidewall having a gas inlet port, a top wall including a gas outlet port, and a bottom wall, a water outlet port is attached to the sidewall or the bottom wall, the gas inlet port includes an internal surface and is configured to receive an input stream from an anode side of the fuel cell system;
an inner protection tube positioned within the outer cylindrical tank in fluid communication with the gas outlet port, the inner protection tube configured to allow separated gas flow to the gas outlet port while preventing liquid water from being carried into the gas outlet port, the inner protection tube defining an entry opening for receiving the separated gas flow, wherein the top wall includes a plurality of concentric ribs to inhibit water from entering the inner protection tube; and
a water separator between the inner protection tube and the water outlet port configured to inhibit water splash back into the inner protection tube.
